(19) United States
(12) Patent Application Publication
(10) Pub. No.: US 2010/0129674 A1
(43) Pub. Date: May 27, 2010

(54) AMINOBENZOIC ACID POLYMER COMPOSITIONS AND FILMS; METHODS OF FORMING AND USING THE SAME

(75) Inventors: Chang Wei, Niskayuna, NY (US); Yanrong Zhu, Shanghai (CN); Shengxian Wang, Shanghai (CN)

Correspondence Address: MCANDREWS HELD & MALLOY, LTD, 500 WEST MADISON STREET, SUITE 3400, CHICAGO, IL, 60661, US

(73) Assignee: CHEMETALL CORP., New Providence, NJ (US)

(21) Appl. No.: 12/342,871

(22) Filed: Dec. 23, 2008

Related U.S. Application Data
(60) Provisional application No. 61/116,799, filed on Nov. 21, 2008.

(51) Int. Cl. H01B 1/12; C08K 3/10; C08K 3/36; C08L 77/00; C08G 69/12; B32B 15/08; B32B 27/34

(52) U.S. Cl. 428/458; 524/401; 524/435; 524/437; 524/606; 525/431; 528/312; 528/315; 528/331; 252/500; 428/477.7

(57) ABSTRACT

A copolymer is disclosed, having aminobenzoic or substituted aminobenzoic and comonomer repeating units. Methods of preparing the copolymer by polymerizing a reaction mixture comprising aminobenzoic acid in the presence of at least one strong acid and optionally at least one initiator are disclosed. Compositions and films comprising at least one such copolymer, composites comprising a film as described above overlaid by another coating, methods of coating a metal surface with such a composition or film, and methods of protecting a metallic surface comprising applying to the surface a film comprising an electroconductive copolymer as described above are also disclosed.

### RELATED APPLICATIONS

This application claims the benefit of U.S. Provisional Application No. 61/116,799, filed Nov. 21, 2008, which is incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

The present description relates to coatings, which may optionally be electrically conductive coatings, corrosion inhibiting coatings, adhesion imparting coatings, or coatings having any two or more of these functional features. Coatings having other functionality or not having the foregoing functionality are also contemplated.

U.S. Publ. Appl. Nos. 2003-0001143 and 2006-0151070 may have relevance to the present subject matter.

### BRIEF SUMMARY

An aspect of the present invention is a copolymer, characterized in that it comprises aminobenzoic and aniline repeating units and optionally other comonomer repeating units. The aminobenzoic repeating units are independently selected from:

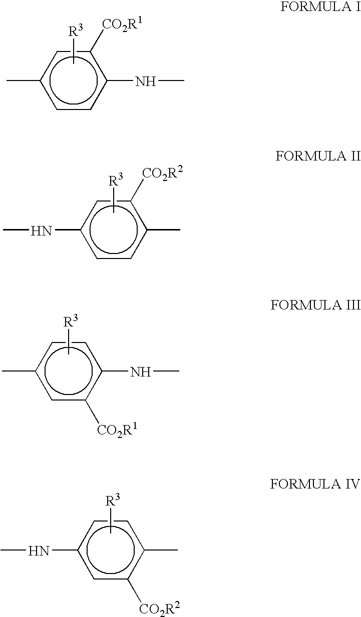

and a combination of two or more of these, in which the R¹ and R² moieties of each unit are independently selected from H, alkali metal, ammonium, RO— with R being an alkyl group with 1 to 10 carbon atoms, and in which there are 1 to 3 R³ moieties with each R³ being independently selected from hydrogen, —OH, oxygen, ammonium, monovalent metal ions, divalent metal ions, trivalent metal ions, or a combination of two or more of these. The contemplated comonomers are described below. There may be 1 to 3 groups R³ which may use one to three open positions that are not covered by —CO₂R¹ or —CO₂R².

Another aspect of the invention is a composition comprising at least one copolymer as described above.

Another aspect of the invention is a film of the composition as described above, formed on a substrate.

Another aspect of the invention is a composite comprising at least one film as described above, overlaid by at least one coating.

Another aspect of the invention is a method of coating a metal surface. A metal surface is provided. A film is applied onto the metallic surface by contacting the metallic surface with a composition as described above, and at least one coating is applied onto the film.

Another aspect of the invention is a method of preparing a polymer comprising polymerizing aminobenzoic acid in the presence of at least one strong acid and optionally at least one initiator.

Another aspect of the invention is a method of protecting a metallic surface comprising applying to the surface a film comprising an electroconductive copolymer as described above.

The foregoing list of aspects of the invention and the following detailed description are representative, not comprehensive, and do not limit the scope of the invention by inclusion or exclusion. Other aspects of the invention will become apparent from the following detailed description. The inventors intend to claim the full scope of their invention as defined in the claims at the end of this specification, not limited to embodiments that achieve any objects, features, or results described in this specification.

### BRIEF DESCRIPTION OF SEVERAL VIEWS OF THE DRAWINGS

[Not Applicable]

### DETAILED DESCRIPTION

Copolymer Structure

The term copolymer in this description shall include block copolymer, which may be optionally a block copolymer having several sequences of blocks.

The copolymer as described in the summary is, broadly, a copolymer of aminobenzoic acid or a substituted analog of aminobenzoic acid and a second comonomer. The aminobenzoic acid precursor or repeating unit, or optionally both, optionally can be ortho-aminobenzoic acid, meta-aminobenzoic acid, or combinations of these, either unsubstituted or substituted on the phenyl ring.

The copolymer optionally can be characterized in that it comprises aminobenzoic repeating units and comonomer repeating units.

The aminobenzoic repeating units are independently selected from Formulas I-IV and a combination of two or more of these, as described previously.

As illustrated, it is contemplated that many or all of the phenyl rings in the polymer backbone are para-linkages, meaning that the two points of attachment of the phenyl ring to the remainder of the backbone are respectively at the 1 and 4, 2 and 5, or 3 and 6 carbon atoms of the phenyl ring. A para arrangement lends conductivity to the polymer, while a meta arrangement lends little or no conductivity.

Some representative non-metallic R³ substituents in the above formula include but are not limited to hydrogen, OH—, oxygen, ammonium, —COOH, —CH₂OH, —OCH₃, —CₙH₂ₙ₊₁, especially where n=from 2 to 12, OCₙH₂ₙ₊₁, especially where n=from 2 to 12, alkoxy, aryl, amine, amino, amide, imine, imino, imide, halogen, carboxy, carboxylate, mercapto, phosphonate, S, sulfone, sulfonate, or combinations of any two or more of these.

Some representative metallic R³ substituents include but are not limited to alkali metal, alkaline earth metal, Group 3a metal, lanthanide, transition metal, or a combination of two or more of these. Some more particular R³ substituents include but are not limited to Al³⁺, Y³⁺, Ca²⁺, Ce²⁺, Ce³⁺, Co²⁺, Cu³⁺, Cu²⁺, Fe²⁺, K⁺, Li⁺, Mg²⁺, Mn²⁺, Na⁺, Ni²⁺, Zn²⁺, Ti⁴⁺, Zr⁴⁺ or combinations of any two or more of these. Metallic and non-metallic R³ substituents also can optionally be combined or respectively used on the same or different repeating units of the copolymers.

The aminobenzoic repeating units in the copolymers optionally can provide electrical conductivity to a coating or film containing the copolymer. Without limiting the scope of the invention by the accuracy of this theory, it is contemplated that a degree of electrical conductivity of the film is related to its ability to prevent or retard corrosion of a metallic layer coated with the film, or to promote adhesion of an overlying coating, or both. In the following, PAAA is used as abbreviation for poly(aniline aminobenzoic acid).

The polyanilines are understood to behave according to the following theory, although the scope of the invention is not limited according to the accuracy of this theory. The following description is adapted from a 2008 Wikipedia entry on polyanilines. According to this theory, polyanilines can be found in one of five idealized oxidation states, based on the structure shown in the following formulation:

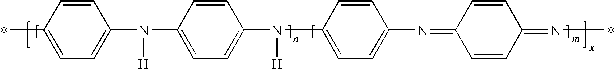

In which n+m=1 and x=degree of polymerization. The above formula is not an exact representation, in the sense that the copolymer can be a random copolymer or an alternating copolymer, as well as the illustrated block copolymer.

The following oxidation states of the polyaniline repeating units are defined, with typical but non-limiting colors of the polyaniline materials in these oxidation states listed.

leucoemeraldine—white/clear

protoemeraldine

emeraldine—green or blue

nigraniline

pernigraniline—blue/violet

Leucoemeraldine with n=1, m=0 is the fully reduced state. Pernigraniline is the fully oxidized state (n=0, m=1) with imine links instead of amine links. The emeraldine (n=m=0.5) form of polyaniline, often referred to as emeraldine base (EB), is either neutral or doped, with the imine nitrogens protonated by an acid. Emeraldine base is regarded as the most useful form of polyaniline due to its high stability at room temperature and the fact that upon doping the emeraldine salt form of polyaniline is electrically conducting. Leucoemeraldine and pernigraniline are poor conductors, even when doped with an acid.

The remaining repeating units or comonomers or chain constituents in the copolymers can broadly be any type of material that will form a copolymer with the previously defined aniline/aminobenzoic repeating units. For example, aniline, pyrrole, thiophene, or a combination of two or more of these can be used. An A-B-A-B . . . copolymer of aniline and aminobenzoic acid can be made by polymerizing aminobenzoic acid alone under conditions, such as those of Example 1 of this specification, that remove the carboxyl moiety from every second repeating unit. Additional aniline can be added to the reaction to change the ratio of the aminobenzoic and the aniline repeating units. Additionally, other comonomers can be reacted in to provide other copolymers.

Anions can be incorporated into the copolymers, as by oxidation. These anions can be selected in particular from those based on alkanoic acids, arenoic acids, boron-containing acids, fluorine-containing acids, heteropoly acids, isopoly acids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof.

In particular, anticorrosive mobile anions are contemplated. Representative anions are those based on benzoate, carboxylate, such as, for example, lactate, dithiol, fumarate, complex fluoride, lanthanate, metaborate, molybdate, a nitro compound, such as, for example, based on nitrosalicylate, octanoate, phosphorus-containing oxyanions, such as, for example, phosphate and/or phosphonate, phthalate, salicylate, silicate, sulfoxylate, such as, for example, formaldehyde sulfoxylate, thiol, titanate, vanadate, tungstate and/or zirconate, particularly alternatively at least one anion based on titanium complex fluoride and/or zirconium complex fluoride.

Alternatively or in addition, at least one type of adhesion-promoting anion is contemplated. The adhesion-promoting anions can be based on phosphorus-containing oxyanions, such as, for example, phosphonate, silane, siloxane, polysiloxane and/or the anions of anionic surfactants.

At least one type of corrosion-inhibiting and/or adhesion-promoting anion can be provided in the copolymer, alternatively a mixture of at least two types of anions, particularly alternatively a mixture based on at least one of the above-mentioned anticorrosive movable anions with at least one type of the above-mentioned adhesion-promoting anions, in particular selected from those based on carboxylate, complex fluoride, molybdate, nitro compound, phosphonate, polysiloxane, silane, siloxane and/or surfactant, very particularly alternatively a mixture based on at least one of the above-mentioned anticorrosive mobile anions with at least one type of the above-mentioned adhesion-promoting anions. In particular, a mixture of anion types selected from anion types on the one hand based on carboxylate, complex fluoride, molybdate and nitro compound and on the other hand based on phosphorus-containing oxyanions, polysiloxane, silane, siloxane and/or anionic surfactant is used.

The molar ratio of the comonomer repeating units to the sum of Formula I and Formula II repeating units can optionally be in the range from 1:99 to 99:1, alternatively from 40:60 to 95:5, alternatively from 75:25 to 90:10.

The copolymer can optionally have a weight average molecular weight of from 100 to 20,000 atomic mass units, alternatively from 1,000 to 10,000 atomic mass units. Smaller oligomers, e.g. those wherein about the number of repeating units, n, is 8 or fewer, scarcely exhibit or do not exhibit the effects of the conductive polymers. Thus, the use of longer oligomers or polymers is preferred.

Optionally, the comonomer repeating units can be at least partially in the emeraldine oxidation state, optionally essentially in the emeraldine state, optionally entirely in the emeraldine oxidation state.

Copolymer Preparation

In the described method for preparing copolymers, at least one starting material for the preparation of at least one depot substance (i.e. an electroconductive copolymer) is alternatively selected from monomers and/or oligomers of aniline, aminobenzoic acid and their derivatives. Electrically conductive copolymers or block copolymers—all referred to in the following together as depot substances or as conductive polymers—can be formed.

Exemplary starting materials based on aminobenzoic acid are:

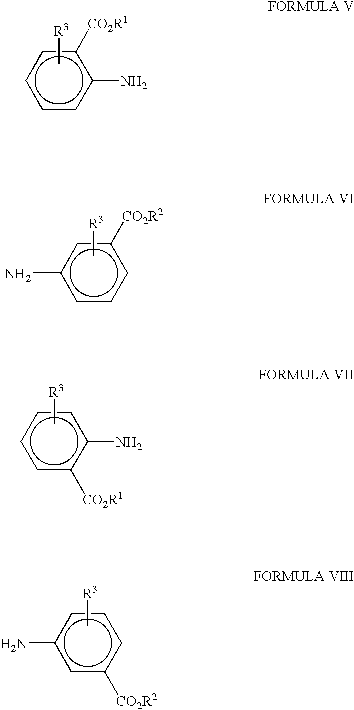

in which the substituents are as previously defined for Formulas I through IV.

The CO₂R¹, CO₂R², and R³ groups in the starting materials, or corresponding reaction products in the polymers, influence significantly the solubility in water, organic solvents, or mixtures of water and organic solvents.

Aminobenzoic acid and its derivatives as shown can be polymerized in the presence of at least one strong acid and optionally at least one initiator. The strong acid can be, for example, hydrochloric acid, nitric acid, sulfuric acid, perchloric acid, combinations of any two or more of these, or other acids.

The conductive polymers/copolymers are electrically neutral in the reduced state. In the oxidation of the conductive polymers/copolymers, cations form, which are correspondingly able to absorb anions. The oxidized state can be established chemically with at least one oxidizing agent, electrochemically and/or photochemically. It is preferable to work only or largely only chemically. It is preferred not to carry out electropolymerization but to effect polymerization chemically. The conductive polymers/copolymers have a salt-like structure, so that the term salts can be used in the case of anion-loaded conductive polymers.

There can be chosen as substituents in the case of the starting materials and/or polymers, in each case independently of one another, alternatively —H, —OH, —O—, —COOH, —CH₂OH, —OCH₃, —CₙH₂ₙ₋₁, especially where n=from 2 to 12, —OCₙH₂ₙ₋₁, especially where n=from 2 to 12, alkyl, alkoxy, aryl, amine, amino, amide, primary ammonium, imino, imide, halogen, carboxy, carboxylate, mercapto, phosphonate, S, sulfone and/or sulfonate, or mixtures of any two or more of these.

It may be advantageous to use either a conductive copolymer modified by substituents and/or by a different base molecule (monomer/oligomer) and/or a conductive copolymer containing at least two different base molecules (monomers/oligomers) having slightly different redox potentials, in order to vary the redox properties of the depot substance from compound to compound. Alternatively or additionally, correspondingly different depot substances can be mixed with one another. As a result, it is possible to select at least one compound that has the correct level of redox potential for the chemical system, including the metal surface. The redox potential of the depot substance is particularly suitable when it is at least 75 mV, at least 100 mV or at least 150 mV, alternatively at least 200 mV or at least 250 mV, very particularly alternatively at least 300 mV or at least 350 mV, above the corrosion potential of the metal surface.

For inhibiting the corrosion of metal surfaces, there are used depot substances based on polyanilines according to the invention together with derivatives of Brönstedt acids, which are incorporated as anions. The inhibiting anion may be released via a protonation reaction (e.g. an emeraldine salt decomposes into an emeraldine base and a Brönstedt acid, which contains the anion, and not via a redox reaction).

With conductive polymers, it may be distinguished whether they are polymerized chemically or electrochemically, because in electrochemical polymerization the comparatively base metal surface is typically passivated prior to the deposition of the copolymer: For example, the metal surface is first passivated when oxalate salts are used.

A depot substance can in principle have been polymerized chemically, electrochemically and/or photochemically. Alternatively, the at least one depot substance, or the composition containing it, is applied electrochemically and/or mechanically in particular to the metal surfaces. In the case of electrochemical application, the comparatively more base metal surfaces is favorably passivated beforehand in order to suppress a pronounced dissolution of the metal substances. In the case of electrochemical application, therefore, corrosion-inhibiting anions are favorably added to the solution from which at least one starting material is polymerized, in order first to form a passivating layer. The conductive copolymer formed in this manner accordingly contains corrosion-inhibiting anions, but the publications of the prior art that describe corrosion-inhibiting anions typically do not mention a release of these anions owing to a potential drop.

The conductive copolymer so formed contains corrosion-inhibiting anions, which may be released of those anions owing to a potential drop.

It is probably only possible for an anion to be released by reduction from the film that is produced, if the multifunctional polymeric organic anions used are not too large.

The inhibiting anion may be an anion of an acid or an anion of a salt.

In the method according to the invention there are alternatively chosen at least one depot substance and at least one anion that allow the anions to be released largely or wholly from the depot substance, as a result of which the cation transport rate of the cations in particular from the electrolyte and/or from the defect can be markedly reduced, which in turn allows the formation of harmful radicals in the region of the metal/coating interface to be reduced.

For the preparation of the at least one depot substance there is conventionally required, in addition to at least one starting material and at least one anion that can be incorporated into the depot substance, at least one oxidizing agent, in so far as an agent such as, for example, at least one added anion does not already act as oxidizing agent.

The oxidizing agent for the chemical conversion may be at least one based on H₂O₂, such as for example barium peroxide, peracetic acid, perbenzoic acid, permanganic acid, peroxomonosulfuric acid, peroxodisulfuric acid, a Lewis acid, molybdic acid, niobic acid, tantalic acid, titanic acid, tungstic acid, zirconic acids, yttrium-containing acid, lanthanide-containing acid, Fe³⁺-containing acid, Cu²⁺-containing acid, their salts, their esters and/or their mixtures.

There can be used as the oxidizing agent, for example, at least one compound based on acids whose salts can be present in several valence stages, such as, for example, iron salts, based on peroxides and/or per-acids, such as, for example, peroxodisulfate.

The anions that can be incorporated into the depot substance(s) by oxidation can be selected in particular from those based on alkanoic acids, arenoic acids, boron-containing acids, fluorine-containing acids, heteropolyacids, isopolyacids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof.

The at least one type of anticorrosive mobile anion is alternatively at least one based on benzoate, carboxylate, such as, for example, lactate, dithiol, fumarate, complex fluoride, lanthanate, metaborate, molybdate, a nitro compound, such as, for example, based on nitrosalicylate, octanoate, phosphorus-containing oxyanions, such as, for example, phosphate and/or phosphonate, phthalate, salicylate, silicate, sulfoxylate, such as, for example, formaldehyde sulfoxylate, thiol, titanate, vanadate, tungstate and/or zirconate, particularly alternatively at least one anion based on titanium complex fluoride and/or zirconium complex fluoride.

The at least one type of adhesion-promoting anion is alternatively at least one based on phosphorus-containing oxyanions, such as, for example, phosphonate, silane, siloxane, polysiloxane and/or a surfactant.

The at least one type of corrosion-inhibiting and/or adhesion-promoting anions alternatively is a mixture of at least two types of anions, particularly alternatively a mixture based on at least one of the above-mentioned anticorrosive movable anions with at least one type of the above-mentioned adhesion-promoting anions, in particular selected from those based on carboxylate, complex fluoride, molybdate, nitro compound, phosphonate, polysiloxane, silane, siloxane and/or surfactant, very particularly alternatively a mixture based on at least one of the above-mentioned anticorrosive mobile anions with at least one type of the above-mentioned adhesion-promoting anions. In particular, a mixture of anion types selected from anion types on the one hand based on carboxylate, complex fluoride, molybdate and nitro compound and on the other hand based on phosphorus-containing oxyanions, polysiloxane, silane, siloxane and/or surfactant is used.

At least one type of releasable anions is alternatively one that is mobile in water, in at least one other polar solvent and/or in a solvent mixture containing at least one polar solvent. It is particularly preferred for the at least one type of releasable anions to be soluble in water, in at least one other polar solvent and/or in a solvent mixture containing at least one polar solvent at least in a small amount, so that it is advantageous if water, at least one other polar solvent and/or a solvent mixture containing at least one polar solvent are present for dissolving anions. As far as the mechanisms are understood, the release may be by change of pH value or by change of potential difference or both.

The anions do not have to be anions of an acid but can also be, for example, anions of a salt. The at least one type of releasable anions is incorporated into the conductive copolymer via an oxidation reaction. When the anions are released, it may be possible to have a change in pH value in the electrolyte to occur at the coating in the region of the defect, and this pH change may perhaps be used as a signal for triggering the release of the anions.

Copolymer Composition

Compositions of the copolymers can be formulated for application to metal surfaces. The proportions for the copolymer composition given below are percent by weight of the liquid composition, including water and/or any organic solvent present.

One ingredient of the compositions is one or more of the copolymers defined above, dispersed in a suitable liquid. While non-water dispersing liquids can be used, the desire for a composition minimizing or being free of volatile organic compounds (VOCs) usually dictates a water-based liquid, for example water. Preferred compositions for industrial use are water-based and essentially free of VOCs, and contain predominantly or entirely water-soluble or water-dispersible ingredients.

Other useful solvents which can be used, optionally as a co-dispersing agent with water, include the following.

In a solvent mixture, at least one solvent selected from more or less polar, dipolar aprotic and dipolar protic liquids can be added as the at least one further solvent. The polarity and thus the dielectric constant may in this connection be varied within wide ranges. Weakly polar liquids such as chloroform and/or dichloromethane or dipolar aprotic liquids such as acetonitrile and/or propylene carbonate are used in particular for those educts in which the process cannot be carried out with water—in particular for compounds for example based on thiophenes. Polar protic liquids such as water and/or alcohols are generally used for the oxidizing agents and anions. Solvents of lesser polarity, such as for example alcohols, are alternatively used to dissolve the educts, while solvents of high polarity, such as for example water, are alternatively used to dissolve the oxidizing agents and salts as well as to dilute the acids.

Alternatively in a solvent mixture at least one solvent selected from acetonitrile, chloroform, dichloromethane, ethanol, isopropanol, methanol, propanol, propylene carbonate and water can be added as the at least one further solvent. Often solvent mixtures of water with at least one alcohol can be used, which optionally may also contain at least one further solvent and/or also at least one further liquid which, such as for example an oil, is not a solvent.

It is also particularly advantageous to use a solvent mixture consisting of water and at least one organic solvent, since for example molybdate is sufficiently soluble at the necessary concentration virtually only in water and since some pyrrole derivatives are normally sufficiently soluble at the necessary concentration only with at least a minor addition of at least one water-miscible organic solvent, the content of the at least one organic solvent in the solvent mixture being in particular at least 2 wt. %, alternatively at least 6 wt. %, particularly alternatively at least 12 wt. %, most particularly alternatively at least 18 wt. % and especially even at least 24 wt. %.

The copolymer optionally can be present as from 0.001 to 20% by weight of the liquid composition, alternatively from 0.01 to 10% by weight of the composition, alternatively from 0.05 to 7% by weight of the composition, alternatively from 0.1 to 4% by weight of the composition.

The composition optionally further contains at least one other organic polymer, at least one other copolymer, at least one acid, at least one amine compound, at least one carboxylic compound, at least one surfactant, at least one type of nanoparticles, at least one UV absorber, at least one photoinitiator, at least one pH influencing agent and/or at least one (further) additive.

The optional second organic polymer of the copolymer composition can be a water-dispersible polymer. This polymer can be, for example, an aniline homopolymer, a pyrrole homopolymer, a thiophene homopolymer, or a copolymer comprising any two or more of aniline, pyrrole, and thiophene repeating units. The second polymer as well can be dissolved or dispersed in the same medium, for example water. Several contemplated examples are aniline, anisidine, toluidine, trimethylamine, or triethanolamine from 0.1 to 10%.

The composition can have a pH of from 3.5 to 8, alternatively from 4.5 to 7, alternatively from 5.0 to 6.5. If the composition does not have the appropriate pH already, the composition can include at least one type of pH influencing agent, present in an amount sufficient to achieve the desired pH.

The composition optionally can include at least one acid. In some cases, the at least one acid may be at least one mineral acid like nitric acid, phosphoric acid, phosphomolybdic acid, phosphotungstic acid, a phosphonic acid, sulfuric acid or any combination thereof or at least one organic acid like benzoic acid, citric acid, formic acid, lactic acid, salicylic acid, humic acid, at least one carboxylic compound not within Formula I or Formula II, fumaric acid, maleic acid, o-pathilic acid, or any other carboxylic acid or any combination thereof or any combination of at least one mineral acid and at least one organic acid. In many cases, at least one acid contained in the composition can be an acid of a corrosion inhibiting anion. There can be used as the oxidizing agent, for example, at least one compound based on an acid whose salts can be present in several valence stages, such as, for example, iron salts, based on peroxides and/or per-acids, such as, for example, peroxodisulfate. Such acids or their salts can be selected in particular from those based on alkanoic acids, arenoic acids, boron-containing acids, fluorine-containing acids, heteropolyacids, isopolyacids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof. The content of the at least one acid can be alternatively in the range of from 0.001 to 12% by weight of the liquid composition, more preferred from 0.01 to 8% by weight of the composition, most preferred from 0.1 to 5% by weight of the composition, alternatively from 0.5 to 2% by weight of the composition.

For examples, sodium dihydrogen phosphate-disodium hydrogen phosphate solution, disodium hydrogen phosphate-potassium dihydrogen phosphate solution, potassium dihydrogen phosphate-sodium hydroxide solution can be used.

The copolymer composition optionally can include at least one alkaline agent. The at least one alkaline agent may assist to adapt the pH, e.g. to stabilize the aqueous copolymer composition with at least one pH sensitive compound. Examples of suitable alkaline agents include a water-soluble hydroxide such as an alkali metal or ammonium hydroxide or a combination of two or more of these. Specifically contemplated alkali metal hydroxides are sodium hydroxide or potassium hydroxide or a combination of these.

The composition optionally can include at least amine, which is able to absorb free radicals which form during the oxygen reduction, as a result of which delamination of the final coating can be stopped or slowed. The content of the at least one acid can be alternatively in the range of from 0.001 to 6% by weight of the liquid composition, alternatively from 0.01 to 4% by weight of the composition, most alternatively from 0.1 to 2% by weight of the composition.

The composition optionally can include at least one adhesion promoter. One contemplated adhesion promoter is a silane or comprises at least one silane. The term “silane” as used here includes silanes, silanols, siloxanes, or polysiloxanes which may be added as silanes silanols, siloxanes, or mixtures of any two or more of these. The weight of silane added calculated on the base of the respective silane.

Some examples of suitable categories of silane adhesion promoters are alkoxysilanes, diethoxysilanes, triethoxysilanes, mono-silanes, bis-silanes, tris-silanes, branched silanes, aminosilanes, epoxysilanes, iminosilanes, mercaptosilanes, ureasilanes, ureidosilanes or any combination of two or more of these in one or more of the above categories. Some examples of suitable combinations are at least one mono-silane with at least one bis-silane at least one mono-aminosilane with at least one bis-aminosilane.

Some more specific examples of suitable silanes are the following:

3-glycidoxypropyltriethoxysilane (GPTES),

3-glycidoxypropyltrimethoxysilane (GPTMS),

(3-aminopropyl)triethoxysilane (APTES),

(3-mercaptopropyl)triethoxysilane (MPTES),

(3-mercaptopropyl)trimethoxysilane (MPTMS),

(3-glycidoxypropyl)dimethylethoxysilane (GPMES),

N-(2-aminoethyl)-3-aminopropyltriethoxysilane (AEAPTES),

N-(2-aminoethyl)-3-aminopropyltrimethoxysilane (AEAPTMS),

3-aminopropylethyidiethoxysilane (APEDES), 3-aminopropylmethyidiethoxysilane (APMDES),

Aminopropyltriethoxysilane (APTES),

Bis-(trimethoxysilylpropyl)amine (Bis-silyl amine),

Bis-(triethoxysilylpropyl)amine (BAS),

Bis-1,2-(triethoxysilyl)ethane (BTSE) or

a combination of two or more of these.

The composition optionally can include at least one surfactant, although alternatively the composition can be formulated and/or used in such way that there is no or nearly no foam generated. The at least one surfactant may help to generate homogeneous films on the surface of any object like a metallic article. The content of the at least one surfactant can be alternatively in the range of from 0.001 to 4% by weight of the liquid composition, alternatively from 0.01 to 5% by weight of the composition, most alternatively from 0.1 to 2% by weight of the composition. Several anionic surfactants that may be suitable are sodium lauryl sulfate, sodium dodecylbenzene sulfonate, ammonium perfluoroalkyl sulfonate, sodium dihexyl sulfosuccinate, or sodium alkyl polyglycolether sulfate Some of the nonionic surfactants contemplated to be suitable are nonylphenol polyglycol ethers and alkyl polyglycol ethers.

The composition optionally can include at least one at least one type of particles. The proportion of the particles can be from 0.001 to 50%, alternatively 0.01 to 20%, alternatively 0.1 to 10%, alternatively 0.1 to 6% alternatively from 0.5 to 2% by weight of the liquid composition. Such particles can be, for example, nanoparticles. Nanoparticles are defined as those sized no greater than 100 nanometers (nm.) in diameter, optionally no greater than 10 nm, optionally 1 nm or less in diameter. A particle size range from 1 nm to 100 nm is alternatively contemplated. Examples of suitable nanoparticles are SiO₂, any silicate, and other oxide nanoparticles such as Al₂O₃, TiO₂, ZnO, or ZrO₂, optionally chemically surface modified with hydroxyl, methoxyl, ethoxyl, or silanes-to bring hexyl, phenyl, octyl, epoxyl, methacrylics or mercaptan.

The composition optionally can include at least one type of UV adsorber. Numerous types of UV absorbers are well known in the art. Some examples are benzophenone, benzotriazole, 2-Hydroxy-4-n-octoxybenzophenone, 2,2′-dihydroxy-4,4′-dimethoxybenzophenone, 2,2′-Methylene bis-(4-t-octyl-6-(benzotrilazolyl)-phenol) and Bis(1,2,2,6,6-pentamethyl-4-piperidyl)sebacate. The content of the at least one UV adsorber can be alternatively in the range of from 0.001 to 12% by weight of the liquid composition, more preferred from 0.01 to 8% by weight of the composition, most preferred from 0.1 to 4% by weight of the composition, alternatively from 0.5 to 2% by weight of the composition.

The composition optionally can include at least one type of photoinitiator. Many types of photoinitiators are well known in the art. The content of the at least one photoinitiator can be alternatively in the range of from 0.001 to 12% by weight of the liquid composition [calculated inclusive water and/or organic solvent(s) ?], more preferred from 0.01 to 8% by weight of the composition, most preferred from 0.1 to 4% by weight of the composition, alternatively from 0.5 to 2% by weight of the composition.

The photoinitiator can be selected but not limited to diphenyl ketone, 2,4,6-Trimethylbenzoyl-diphenyl phosphine, acetophenone, benzyl, dibenzosuberenone and phenanthrenequinone.

The composition optionally can include at least one type of pigment particles. The pigment optionally can be present as from 0.1 to 50% by weight of the composition. Particle size can be from 0.1 μm to 1000 μm. Particles of tungsten, tungsten alloy, or other electroconductive materials like iron phosphide, or any combination of these can be used. Other suitable particles can be made of or based of, aluminum, aluminum alloy, zinc alloy or any combination thereof. In some embodiments, at least one type of pigment particles may be surface-treated. Alternatively or additionally, there may be a content of pigment particles on the base of particles made of or containing a certain content of any electroconductive polymer like on the base of polythiophene, polypyrrole, polyaniline or any combination thereof. The content of the at least one type of pigment particles can be alternatively in the range of from 0.001 to 25% by weight of the liquid? composition [calculated inclusive water and/or organic solvent(s)?], alternatively from 0.01 to 15% by weight of the composition, most alternatively from 0.1 to 8% by weight of the composition, alternatively from 0.5 to 4% by weight of the composition.

The particles can be made of aluminum, aluminum alloy, tin, tin alloy, zinc, zinc alloy, zinc-magnesium alloy, graphite, root or similar carbon varieties or any combination of these.

A specifically contemplated composition of these materials includes, for example, the following:

from 0.01 to 30 weight % of a copolymer as defined above,

from 0.001 to 20 weight % of an adhesion promoter as defined above, and

from 99.98 to 30 weight % water.

Another specifically contemplated composition of these materials includes, for example, the following:

from 0.05 to 20 weight % of a copolymer,

from 0.01 to 12 weight % of an adhesion promoter, and

from 99.5 to 40 weight % water.

Another specifically contemplated composition of these materials includes, for example, the following:

from 0.1 to 12 weight % of a copolymer,

from 0.05 to 6 weight % of an adhesion promoter, and

from 99.0 to 50 weight % water.

Yet another specifically contemplated composition of these materials includes, for example, the following:

from 0.2 to 8 weight % of a copolymer,

from 0.1 to 2 weight % of an adhesion promoter, and

from 98 to 60 weight % water, alternatively from 95 to 70 weight % water, alternatively from 92 to 80 weight % water.

Optionally also at least one film-forming aid can be present in the copolymer composition. For example organic binders and/or inorganic binders, such as, for example, based on synthetic resins, natural resins, SiO₂, water glass (sodium silicate solution) variants, inorganic silicates, organic silicates, such as, for example, alkyl silicates, silanes, siloxanes, polysiloxanes, silylated polymers, plasticizers, such as, for example, based on phthalates, reactive diluents, such as, for example, based on styrene and/or caprolactam, crosslinkable—so-called “drying”—oils, polysaccharides and/or mixtures thereof. Other contemplated ingredients include at least one curing agent or a crosslinker.

Examples of contemplated further ingredients include acid traps, aluminum compounds, antifoaming agents, biocides, cerium compounds, chelates, complex-forming agents, coupling agents, for example based on silanes or polysiloxanes, crosslinking agents, emulsifiers, film-forming auxiliary substances such as for example long-chain alcohols, heavy metal compounds as basic crosslinking agents, inorganic and/or organic corrosion inhibitors, lanthanum compounds, alternatively those having anti-corrosive properties, lubricants, manganese compounds, molybdenum compounds, pigments such as for example anti-corrosive pigments, plasticizers, protective colloids, rare earth compounds, selenium compounds, silanes, siloxanes, or polysiloxanes, for example for the silylation of the organic compounds, solvents, stabilizers for example for the synthetic resins, for the components of the binder system and/or for the particles containing conductive polymer, titanium compounds, alternatively those having anti-corrosive properties, tungsten compounds, waxes such as for example polyethylene waxes, wetting agents such as for example surfactants, yttrium compounds, zinc compounds, and zirconium compounds and combinations of any two or more of these. Preferred are any such ingredients that have anti-corrosive properties. The sum of all the additives, excluding the film-forming auxiliary substances, in the composition can be often substantially 0 wt. % or 0.05 to 10 wt. %, frequently 0.1 to 6 wt. %, sometimes 0.15 to 4 wt. % and in some cases 0.2 to 2 wt. %.

In this connection the protective colloid may if necessary be a polyvinyl alcohol, the acid trap may be ammonia or an acetate, and the complex-forming agent may be ammonia, citric acid, EDTA or lactic acid; the stabilizer may be chosen from water-soluble polymers based on polyvinyl alcohol, polyvinyl alkyl ether, polystyrene sulfonate, polyethylene oxide, polyalkyl sulfonate, polyaryl sulfonate, anionic and/or cationic surfactants, quaternary ammonium salts and tertiary amines.

In the complete copolymer composition, the copolymer alternatively forms an adhesive compact film on a metal surface, optionally with the help of a water soluble silane coupling agent. It is contemplated that the electroactivity of the copolymer composition provides redox activity and then passivates the metal surface. The silane is contemplated to provide adhesion for both the metal substrate and the coating. Since all the components optionally are water soluble, the environment issues are addressed and alternatively minimized or eliminated.

The composition optionally can be entirely free from, essentially free from, or contain a reduced proportion of heavy metals (inclusive of free metals and metal compounds) compared to prior compositions. For example, the composition optionally can be entirely free from chromium, essentially free from chromium, or contain a reduced proportion of chromium. The composition optionally can be entirely free from chromate, essentially free from chromate, or contain a reduced proportion of chromate. The composition optionally can be entirely free from nickel, essentially free from nickel, or contain a reduced proportion of nickel. The composition optionally can be entirely free from molybdenum, essentially free from molybdenum, or contain a reduced proportion of molybdenum. The composition optionally can be entirely free from tungsten, essentially free from tungsten, or contain a reduced proportion of tungsten. The composition optionally can be entirely free from tungsten, essentially free from tungsten, or contain a reduced proportion of tungsten. The composition optionally can be entirely free from volatile organic compounds, essentially free from volatile organic compounds, or contain a reduced proportion of volatile organic compounds compared to prior compositions.

The composition optionally can be entirely free from, essentially free from, or contain a reduced proportion of phosphorus, such as phosphates, and yet can provide performance comparable to current phosphating technology for metal treatment.

The composition can be made, for example, by preparing a water soluble polyaniline copolymer and dissolving in an alkaline aqueous solution of Silance coupling agent. Silance is a trademark of Shin-Etsu Chemical Co., Ltd.

Substrate

The substrate that can usefully be treated with the present copolymer compositions may be, for example, a metallic substrate. Suitable metallic substrates include iron, steel, alloy coated steel, galvanized steel, zinc, zinc alloy, aluminum, aluminum alloy, magnesium alloy, or titanium alloy, a zinc coated metallic substrate, or a zinc-aluminum alloy coated metallic substrate. Nonmetallic substrates and substrates of other metals are also contemplated.

Coating Process

The present copolymer compositions can be used in essentially the same manner as prior compositions. In a typical coating process the metal surface can be cleaned, pre-treated with the copolymer composition, dried, then a further coating, such as a direct topcoat or a primer followed by a topcoat, can then be applied to the treated surface.

Conversion Coating or Passivation Layer

In many variants, before the composition according to the invention containing depot substance can be applied, at least one pretreatment layer can be applied to the cleaned or clean metal surface before a coating containing depot substance can be applied, for example in order to avoid flash rust, e.g. on steel surfaces, to increase the corrosion protection and/or to improve adhesion to the subsequent coating. The types of pretreatment layers or of the subsequent coatings advantageously to be applied to the coating according to the invention, processes for their production and their properties are known in principle. For example, before the coating with at least one copolymer composition, the metal surface to be treated can be cleaned, stripped of coatings, pickled, rinsed, provided with a treatment layer, pre-treatment layer, oil layer and/or with a thin or very thin coating that largely contains conductive polymer and can alternatively be only nearly continuous or completely continuous, and if necessary can be subsequently at least partly freed from this layer.

Optionally a conversion coating can be applied to the bare metallic substrate, before the copolymer film is applied to the conversion coating. In a method according to one aspect of the invention, an adhesion-improving intermediate layer containing OH— groups can be alternatively applied directly to the metal surface and directly beneath the coating containing at least one depot substance, in particular by application of at least one surfactant, at least one copolymer, at least one phosphorus-containing oxyanion, such as, for example, phosphonate, and/or at least one silane/siloxane/polysiloxane. The conversion coating can include, for example, an alkali metal phosphate, zinc phosphate, a titanium compound, a zirconium compound, a phosphonate, a silane, an organic resin, or a combination of any two or more of these.

A passivating layer that under certain circumstances can be improved can optionally be formed on the basis of the positive “more noble” potential of the depot substance(s) compared with the negative “more base” potential of the metal surface and can be alternatively an oxide layer of the metals of the metal surface.

Copolymer Film

A film of any of the previously defined copolymer compositions desirably can be formed on a substrate, as by applying the composition to a substrate and drying the water. The film can be applied over a passivation or conversion coating as defined above.

The film, after any curing or drying steps, can have a conductivity of from 1·10⁻⁸ to 4 S/cm², for example.

The film, after any curing or drying steps, can have a film weight of at least 1 to 2000 mg/m², alternatively 10 to 1200 mg/m², alternatively 100 to 800 mg/m².

Post-Treatment of Copolymer Film

Alternatively the coated metallic surface after the coating with a composition according to claim 1 or 2 can be provided, with at least one further coating based on a post-rinse solution. Post-rinse solutions often have the object of sealing, passivating and/or modifying an already applied coating.

Coating Composite

Once the film is applied, it can be overlaid by at least one coating, selected from a variety of further coatings, to form a coating composite.

The coating can be a primer, paint, single- or multi-layer lacquer, ink, varnish, adhesive, oil, printing, or solder, for example. Optionally, the coating can be a primer, further comprising a finish coat or topcoat overlaying the primer.

The coating optionally can include at least 50% by weight of organic polymeric material, such as the conventional binders of primers, finish coats or topcoats.

The coating optionally can include inorganic material. For example, the coating optionally can include at least one inorganic Ti or Zr compound or a combination of two or more of these. More particularly, the coating can include titanium oxide, titanium hydroxide, zirconium oxide, zirconium hydroxide, or a combination of two or more of these. Other examples of suitable inorganic particles are at least one boride, carbide, carbonate, cuprate, ferrate, fluoride, fluorosilicate, niobate, nitride, oxide, phosphate, phosphide, phosphosilicate, selenide, silicate, sulfate, sulfide, telluride, titanate, zirconate, at least one type of carbon, at least one alloy, of at least one metal or its mixed crystal, of mixtures or intergrowths.

At least one matrix substance can optionally be provided to form a matrix at least in part of the coating, which matrix optionally contains at least one further component. The at least one matrix substance can be in particular at least one organic and/or inorganic substance, such as, for example, a film-forming constituent

In an embodiment, the coating according to the invention can form at least partly a matrix, such as, for example, in the case of an intercalation structure. In a further embodiment, the coating according to the invention can consist largely, substantially or wholly of at least one depot substance and optionally at least one further component; this coating is frequently a more or less uniform or substantially uniform coating, which can be largely or wholly without a matrix. In a third embodiment, there can be mixed forms and/or fluid transitions between the first and second embodiment of the coating according to the invention, it also being possible for a gradient coating to be present or an almost separate first coating on the metal surface, which consists predominantly, largely or substantially of at least one depot substance, and a second coating which consists predominantly, largely or substantially of at least one further component, it being possible for the second coating optionally also to contain at least one depot substance. It can also be a coating according to the invention that consists only or substantially only of at least one depot substance. Small contents in particular of at least one of the substances mentioned in this application and/or at least one reaction product can optionally occur here.

Alternatively, polymers/copolymers containing anionic groups are alternatively added to the coating. Because the charge and the effective ion size often have an effect on the velocity of migration, in many cases it is preferred to use anions of low valence.

Metal Treating Method

In a method according to an embodiment of the invention, a metal surface can be alternatively first cleaned especially thoroughly, in particular in such a manner that the metal surface is cleaned to pure metal, so that all or substantially all contaminants that are not firmly adhering and are not attached to the surface are removed. As a result, complete or virtually complete wetting with the treatment liquid or composition according to the invention can also be achieved. It can be advantageous to match the composition of the cleaner to the type of contamination. The metal surface can be thereby particularly adapted in order to be suitable for the application of an intermediate layer or of a coating containing depot substance. After cleaning, it is recommended to rinse particularly thoroughly and well, in particular to carry out at least two rinsing operations with water, at least one operation alternatively being carried out with demineralized water. Cleaning can optionally be assisted by mechanical aids, such as brushing during cleaning, by electrolytic means and/or by ultrasound.

The copolymer composition can be applied to a metal substrate by roller application, flow coating, knife coating, sprinkling, spray coating, brushing or dipping, and if necessary followed by squeezing off with a roller.

Film Self-Repair

It is contemplated that in at least some instances the copolymer films described here can respond to damage to the coating not only by a change in potential with a gradient of the electrical field and the release of anions associated with the potential drop (release effect), but also exhibit a repair effect.

Thus, it is contemplated to formulate the copolymer film to release corrosion inhibiting anions, or adhesive promoting anions, when any corrosion starts.

### EXAMPLE 1

### PAAA Homopolymer (i.e. 1:1 Copolymer of Aniline and Aminobenzoic Acid): Synthesis and Performance

10 g amino benzoic acid was dissolved in 200 g 1N HCl solution, and 17.4 g sodium persulfate was used as an initiator. The reaction was carried out at room temperature for 48 hours. About 1 g of poly(aniline-aminobenzoic acid) or PAAA homopolymer was obtained.

PAAA homopolymer made as described above was dissolved in about 3% by weight aqueous (3-aminopropyl)triethoxysilane (APTES) to form a pre-treatment composition. The pre-treatment composition was tested for corrosion protection as follows.

ACT Laboratories cold rolled steel (CRS) panels were cleaned with a 90-second spray of 2% Betz Kleen 132 at 140° F. (60° C.). The panels were rinsed with a tap water spray applied for 30 seconds. The panels were then immersed in a bath of the pre-treatment composition for 2 minutes at 140° F. (60° C.). The panels were then rinsed with a de-ionized water flooding rinse for 30 seconds and dried with a hot air gun. After pretreatment, the panels were painted. After painting, the panels were subjected to Neutral Salt Spray tests (NSS) according to ASTM B-117 at 168 hours and rated for creep from the scribe in accordance with ASTM D-1654. The higher the rating values in the following tables are, the better are the results.

NSS results for CRS panels pretreated with the pre-treatment composition after 96 hrs were as shown in Table 1.

TABLE 1

| Sample | | Curing | Creepage, | |
|---|---|---|---|---|
| No. | Sample Description | Temp., ° C. | mm | Rating |
| S2642 | 3% APTES/PAAA | 80° C. | 0 | 10 |
| S2643 | homopolymer | 80° C. | 0 | 10 |
| S2644 | | 80° C. | 0 | 10 |

The rating of “10” in Table 1 for the APTES/homopolymer treatment composition is the highest rating on the 10-point rating scale.

### EXAMPLE 2

### Varying Treatment Compositions

Additional tests were carried out similar to Example 1, using different amounts of the silane coupling agent and different curing temperatures. “CP” is an aniline-aminobenzoic polymer, prepared similarly to the polymer of Example 1. The results are summarized in Table 2.

TABLE 2

| | | | creepage | |
|---|---|---|---|---|
| Sample | | Curing | (average) | |
| No. | Sample Description | Temp., ° C. | (mm) | Rating |
| S801 | 1% APTES + sat. CP | RT (20) | 5 | 4 |
| S802 | | | 6.5 | 4 |
| S803 | | | 6 | 4 |
| S804 | | 50 | 5 | 4 |
| S805 | | | 5 | 4 |
| S806 | | | 5 | 4 |
| S807 | | | >10 | >2 |
| S808 | | | 4 | 5 |
| S809 | | 80 | 5 | 4 |
| S810 | | | 5 | 4 |
| S811 | | | 6 | 4 |
| S812 | 3% APTES + sat. CP | RT | 1 | 7 |
| S813 | | | 1.5 | 7 |
| S814 | | | 0.5 | 8 |
| S815 | | 50 | 1.5 | 7 |
| S816 | | | 1.5 | 7 |
| S817 | | | 1 | 7 |
| S818 | | | 0.5 | 8 |
| S819 | | | 1.5 | 7 |
| S820 | | 80 | 0.5 | 9 |
| S821 | | | 0.5 | 9 |
| S822 | | | 0.5 | 9 |

Table 2 shows that increasing the APTES level and increasing the curing temperature resulted in improved performance: lower creepage and higher ratings.

### COMPARATIVE EXAMPLE 3

### PAAA Copolymer or APTES Alone

Additional testing was carried out using PAAA compositions that did not contain an adhesion aid. The results are shown in Table 3.

TABLE 3

| | | | | |
|---|---|---|---|---|
| | | | Average | |
| | | | creepage | |
| ID | Sample description | Conditions | (mm) | Rating |

| | | | |
|---|---|---|---|
| S327 | CP only in NaOH (5%) | Cure Temp, | All peeled off |
| S323 | | 50° C., Time, | (failure) |
| S329 | CP only in NH4OH | 10 min. | |
| S330 | (5%) | | |

Table 3 illustrates that under the particular test conditions used the copolymer alone failed to provide a coating that adhered adequately.

Similar testing with 3% APTES alone, cured at 80° C., also showed larger average creepage than 3% APTES plus PAAA, cured at 80° C.

### EXAMPLE 4

### Tafel Polarization Testing

PAAA was dissolved in 5% NaCl solution (pH=10). A mild steel circular disk with the area of 0.196 cm² was used as the working electrode. Tafel polarization was carried out with and without the poly(aniline-amino benzoic acid). Corrosion inhibition was observed after adding very little PAAA in the solution. Inhibition in the anodic branch was clearer than in the cathodic branch.

1. A copolymer, characterized in that: it comprises aminobenzoic repeating units and comonomer repeating units, in which the aminobenzoic repeating units are independently selected from: 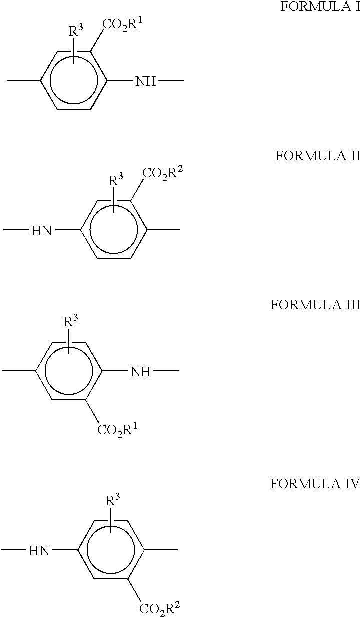
and a combination of two or more of these, in which the R¹ and R² moieties of each unit are independently selected from H, alkali metal, ammonium, RO— with R being an alkyl group with 1 to 10 carbon atoms, and in which there are 1 to 3 R³ moieties with each R³ being independently selected from hydrogen, OH—, oxygen, ammonium, monovalent metal ions, divalent metal ions, trivalent metal ions, or a combination of two or more of these.

2. The copolymer of claim 1, in which R³ is alkali metal, alkaline earth metal, Group 3a metal, lanthanide, transition metal, or a combination of two or more of these.

3. The copolymer of claim 1, in which R³ is Al³⁺, Ca ²⁺, Ce²⁺, Ce³⁺, Co²⁺, Cu³⁺, Cu²⁺, Fe²⁺, K⁺, Li⁺, Mg²⁺, Mn²⁺, Na⁺, Ni²⁺, or Zn²⁺.

4. The copolymer of claim 1, in which the molar ratio of the comonomer repeating units to the sum of Formula I and Formula II repeating units is in the range from 1:99 to 99:1.

5. The copolymer of claim 1, in which the molar ratio of the comonomer repeating units to the sum of Formula I and Formula II repeating units is in the range from 40:60 to 95:5.

6. The copolymer of claim 1, in which the molar ratio of the comonomer repeating units to the sum of Formula I and Formula II repeating units is in the range from 75:25 to 90:10.

7. The copolymer of claim 1, in which the copolymer has a weight average molecular weight of from 100 to 20,000 atomic mass units.

8. The copolymer of claim 1, in which the copolymer has a weight average molecular weight of from 1,000 to 10,000 atomic mass units.

9. The copolymer of claim 1, in which the comonomer repeating units are at least partially in the emeraldine oxidation state.

10. The copolymer of claim 1, in which anions based on alkanoic acids, arenoic acids, boron-containing acids, fluorine-containing acids, heteropolyacids, isopolyacids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof are incorporated into the comonomer repeating units.

11. The copolymer of claim 1, in which corrosion inhibiting anions or adhesion promoting anions or both types of anions are incorporated into the comonomer repeating units.

12. A composition comprising at least one copolymer of claim 1.

13. The composition of claim 12, in which the copolymer is present as from 0.001 to 20% by weight of the composition.

14. The composition of claim 12, in which the copolymer is present as from 0.01 to 10% by weight of the composition.

15. The composition of claim 12, in which the copolymer is present as from 0.05 to 7% by weight of the composition.

16. The composition of claim 12, in which the copolymer is present as from 0.1 to 4% by weight of the composition.

17. The composition of claim 12, further comprising at least one alkaline agent.

18. The composition of claim 17, in which the alkaline agent comprises a water-soluble hydroxide.

19. The composition of claim 17, in which the alkaline agent comprises an alkali metal or ammonium hydroxide or a combination of two or more of these.

20. The composition of claim 12, further comprising at least one adhesion promoter.

21. The composition of claim 20, in which the adhesion promoter is a silane or comprises at least one silane.

22. The composition of claim 20, in which the adhesion promoter comprises at least one alkoxysilane, at least one diethoxysilane, at least one triethoxysilane, at least one mono-silane, at least one bis-silane, at least one tris-silane, at least one branched silane, at least one aminosilane, at least one epoxysilane, at least one iminosilane, at least one mercaptosilane, at least one ureasilane, at least one ureidosilane or any combination thereof.

23. The composition of claim 20, in which the adhesion promoter comprises a combination of at least one mono-silane with at least one bis-silane.

24. The composition of claim 20, in which the adhesion promoter comprises a combination of at least one mono-aminosilane with at least one bis-aminosilane.

25. The composition of claim 20, in which the adhesion promoter comprises:
3-glycidoxypropyltriethoxysilane (GPTES),
3-glycidoxypropyltrimethoxysilane (GPTMS),
(3-aminopropyl)triethoxysilane (APTES),
(3-mercaptopropyl)triethoxysilane (MPTES),
(3-mercaptopropyl)trimethoxysilane (MPTMS),
(3-glycidoxypropyl)dimethylethoxysilane (GPMES),
N-(2-aminoethyl)-3-aminopropyltriethoxysilane (AEAPTES),
N-(2-aminoethyl)-3-aminopropyltrimethoxysilane (AEAPTMS),
3-aminopropylethyidiethoxysilane (APEDES),
3-aminopropylmethyidiethoxysilane (APMDES),
Aminopropyltriethoxysilane (APTES),
Bis-(triethoxysilylpropyl)amine (BAS),
Bis-1,2-(triethoxysilyl)ethane (BTSE) or
a combination of two or more of these.

26. The composition of claim 1, in which the comonomer repeating units comprise aniline linkages.

27. The composition of claim 1, in which copolymers of aminobenzoic repeating units and aniline repeating units are contained in a range of 10 to 99% by weight of all solid and all chemically effective compounds.

28. The composition of claim 1, further comprising a second water-dispersible polymer that is an aniline homopolymer, a pyrrole homopolymer, a thiophene homopolymer, or a copolymer comprising any two or more of aniline, pyrrole, and thiophene repeating units.

29. The composition of claim 1, which further comprises: at least one corrosion inhibitor.

30. The composition of claim 1, which further comprises at least one stabilizer.

31. The composition of claim 1, which further comprises at least one acid.

32. The composition of claim 1, which further comprises at least one amine compound.

33. The composition of claim 1, which further comprises at least one carboxylic compound not within Formula I or Formula II.

34. The composition of claim 1, which further comprises at least one emulsifying agent.

35. The composition of claim 1, which further comprises at least one surfactant.

36. The composition of claim 1, which further comprises at least one type of particles.

37. The composition of claim 1, which further comprises at least one type of nanoparticles.

38. The composition of claim 1, which further comprises at least one type of SiO₂ nanoparticles

39. The composition of claim 1, which further comprises at least one type of chemically surface modified SiO₂ nanoparticles.

40. The composition of claim 1, which further comprises at least one type of UV adsorber.

41. The composition of claim 1, which further comprises at least one type of photoinitiator.

42. The composition of claim 1, which further comprises at least one type of pH influencing agent.

43. The composition of claim 1, which further comprises at least one type of pigment particles.

44. The composition of claim 1, which further comprises pigment particles that are aluminum, aluminum alloy, tin, tin alloy, zinc, zinc alloy, zinc-magnesium alloy, graphite, root or similar carbon varieties or any combination of these.

45. The composition of claim 1 which is essentially free from heavy metals.

46. The composition of claim 1 which is essentially free from chromium.

47. The composition of claim 1 which is essentially free from nickel.

48. The composition of claim 1 which is essentially free from molybdenum.

49. The composition of claim 1 which is essentially free from tungsten.

50. The composition of claim 1 which is essentially free from vanadium.

51. The composition of claim 1 which is essentially free from chromate.

52. The composition of claim 1 which is essentially free from volatile organic compounds.

53. The composition of claim 1 which is essentially free from phosphorus.

54. The composition of claim 12, comprising:
from 0.01 to 30 weight percent, optionally from 0.05 to 20, from 0.1 to 12 or from 0.2 to 8 weight percent, of at least one of the copolymer,
from 0.001 to 20 weight percent, optionally from 0.01 to 12, from 0.05 to 6 or from 0.1 to 2 weight percent, of an adhesion promoter, and from 99.98 to 30 weight percent, optionally from 99.5 to 40, from 99.0 to 50, from 98 to 60, from 95 to 70 or from 92 to 80 weight percent, water.

55. The composition of claim 12, having a pH of from 3.5 to 8 (especially from 4.5 to 7 or from 5.0 to 6.5).

56. The composition of claim 12, in which the copolymer is dissolved or dispersed in water.

57. A dispersion comprising a copolymer according to claim 1 and water and optionally further on at least one further compound.

58. A film of the composition of claim 12, formed on a substrate and dried.

59. A film of the composition of claim 1, formed on a metallic substrate.

60. A film of the composition of claim 1, formed on a steel, zinc, aluminum or alloy coated steel, aluminum, aluminum alloy, magnesium alloy, or titanium alloy.

61. A film of the composition of claim 1, formed on a conversion coating below this film.

62. A film of the composition of claim 1, formed on a conversion coating comprising an alkali metal phosphate, zinc phosphate, a titanium compound, a zirconium compound, a phosphonate, a silane, an organic resin, or a combination of any two or more of these.

63. A film of the composition of claim 58, formed on a zinc, zinc alloy, aluminum alloy, steel, or galvanized steel surface.

64. A film of the composition of claim 58, formed on an iron, steel, zinc coated, zinc-aluminum alloy coated, magnesium alloy, titanium alloy, aluminum or aluminum alloy substrate.

65. The film of claim 58, which has a conductivity of from 1·10⁻⁸ to 4·10⁰ S/cm².

66. The film of claim 58, which has a film weight of at least 1 to 2000 mg/m².

67. The film of claim 58, which has a film weight of 10 to 1200 mg/m².

68. The film of claim 58, which has a film weight of 100 to 800 mg/m².

69. A composite comprising at least one film of claim 58, overlaid by at least one coating.

70. The composite of claim 69, in which the coating comprises at least 50% by weight of organic polymeric material.

71. The composite of claim 69, in which the coating comprises inorganic material.

72. The composite of claim 69, in which the coating comprises at least one inorganic Ti or Zr compound or a combination of two or more of these.

73. The composite of claim 69, in which the coating comprises titanium oxide, titanium hydroxide, zirconium oxide, zirconium hydroxide, or a combination of two or more of these.

74. The composite of claim 69, in which the coating is a primer, paint, lacquer, ink, varnish or adhesive.

75. The composite of claim 69, in which the coating is a primer, further comprising a finish coat overlaying the primer.

76. A method of coating a metal surface comprising:
A. providing a metal surface;
B. applying a film onto the metallic surface by contacting the metallic surface with the composition of any one of claims 12-60; and
C. applying at least one coating onto the film.

77. A method of preparing a polymer comprising polymerizing aminobenzoic acid in the presence of at least one strong acid and optionally at least one initiator.

78. The method of claim 77, in which the strong acid comprises hydrochloric acid.

79. The method of claim 77, in which the strong acid comprises nitric acid.

80. The method of claim 77, in which the strong acid comprises sulfuric acid.

81. The method of claim 77, in which the strong acid comprises perchloric acid.

82. The method of claim 77, wherein the polymer comprises poly(aniline-aminobenzoic acid).

83. A method of protecting a metallic surface comprising applying to the surface a film comprising an electroconductive copolymer according to claim 58.

84. The method of claim 83, wherein the film is formulated to release corrosion inhibiting anions when any corrosion starts.

85. The method of claim 83, wherein the film is formulated to release adhesive promoting anions when any corrosion starts.
